(19) United States
(12) Patent Application Publication
(10) Pub. No.: US 2003/0175572 A1
(43) Pub. Date: Sep. 18, 2003

(54) Fuel cell arrangement and method for operating a fuel cell arrangement

(76) Inventors: Willi Bette, Erlangen (DE); Arno Mattejat, Bubenreuth (DE)

Correspondence Address: HARNESS, DICKEY & PIERCE, P.L.C., P.O.BOX 8910, RESTON, VA, 20195, US

(21) Appl. No.: 10/380,425

(22) PCT Filed: Sep. 3, 2001
(86) PCT No.: PCT/DE01/03366

(30) Foreign Application Priority Data
Sep. 15, 2000 (DE) 100 45 700.2

(51) Int. Cl. H01M 8/04

(52) U.S. Cl. 429/34

(57) ABSTRACT

The invention relates to a fuel cell arrangement (1) comprising a plurality of fuel cells arranged in a protective housing (4). The inventive arrangement is embodied in such a way that it has a long service life and is highly reliable. According to the invention, the inner area (6) enclosed by the housing (4) is connected on the gas side to a closed recirculation circuit (8). A plurality of gas purifying elements are connected advantageously to the recirculation circuit (8) and used to remove water-containing components or components which would otherwise be harmful for built-in elements inside the protective housing (4) from the gas flow (G) which is conducted inside the recirculation circuit (8).

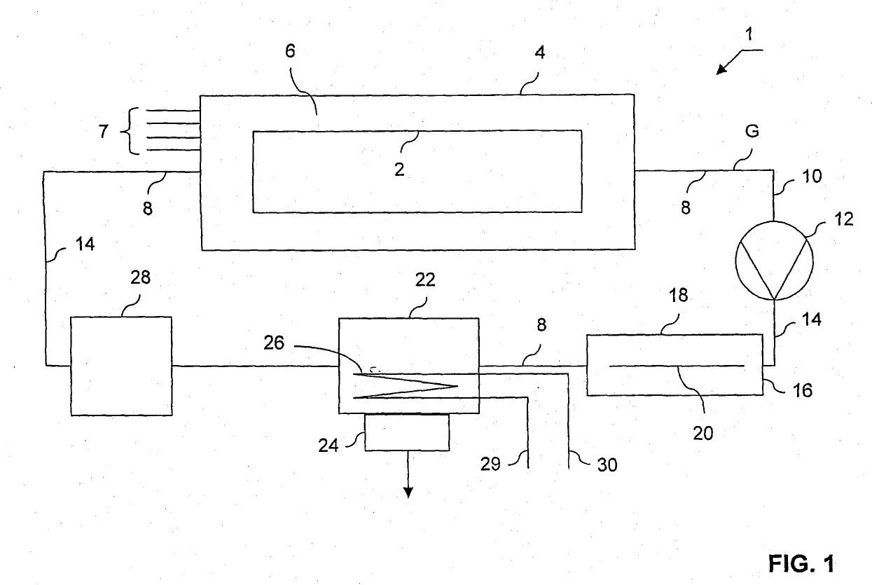

Fuel cell arrangement and method for operating a fuel cell arrangement

The invention relates to a fuel cell arrangement having a number of fuel cells arranged in a protective housing. It also relates to a method for operating a fuel cell arrangement of this type.

Fuel cells can be used for the environmentally friendly generation of electricity. This is because a process which substantially represents a reversal of electrolysis takes place in a fuel cell. For this purpose, in a fuel cell a fuel which includes hydrogen is fed to an anode and an auxiliary substance which includes oxygen is fed to a cathode. The anode and cathode are electrically separated from one another by an electrolyte layer; although the electrolyte layer does allow ion exchange between the fuel and the oxygen, it otherwise ensures gas-tight separation of fuel and auxiliary material. On account of the ion exchange, hydrogen contained in the fuel can react with the oxygen to form water, during which process electrons accumulate at the fuel-side electrode or anode and electrons are depleted at the electrode on the oxidizing agent side, i.e. the cathode. Therefore, when the fuel cell is operating, a usable potential difference or voltage is built up between the anode and cathode, while the only waste product from the electricity generation process is water. The electrolyte layer, which in the case of a high-temperature fuel cell may be designed as a solid ceramic electrolyte or in the case of a low-temperature fuel cell may be designed as a polymer membrane, therefore has the function of separating the reactants from one another, of transferring the charge in the form of ions and of preventing an electron short circuit.

On account of the electrochemical potentials of the substances which are usually used, in a fuel cell of this type, under normal operating conditions, an electrode voltage of approximately 0.6 to 1.0 V can be built up and maintained during operation. For technical applications, in which a significantly higher overall voltage may be required depending on the intended use or the planned load, therefore, it is usual for a plurality of fuel cells to be connected electrically in series, in the form of a fuel cell stack, in such a manner that the sum of the electrode voltages which are in each case supplied by the fuel cells corresponds to or exceeds the required total voltage. Depending on the total voltage required, the number of fuel cells in a fuel cell stack of this type may, for example, be 50 or more.

In a fuel cell arrangement, a fuel cell or a number of fuel cells which have been connected up in this manner to form a fuel cell stack can be enclosed in a protective housing for protection against mechanical damage and/or environmental influences, such as for example spray water or dirt. A protective housing of this type usually surrounds its interior space in a gas-tight and/or water-tight manner, the fuel or the fuel cells which have been combined to form a fuel cell stack being arranged in the interior space of the protective housing.

The invention is based on the object of describing a fuel cell arrangement with a number of fuel cells arranged in a protective housing which has a particularly long durability combined with a high operational reliability. In addition, it is intended to provide a particularly suitable method for operating a fuel cell arrangement of this type.

With regard to the fuel cell arrangement, according to the invention this object is achieved by the interior space which is surrounded by the protective housing being connected into a closed recirculation circuit.

The invention is based on the consideration that, to achieve a particularly long durability of the fuel cell arrangement, the fuel cells arranged in the interior space of the protective housing should as far as possible be kept away from effects which have a detrimental influence on their operational reliability. Particularly in the case of a plurality of fuel cells arranged in a common protective house, however, there are relatively large numbers of connections and feed lines via which operating substances are fed to the corresponding fuel cell. Even if these feeds are provided with highly effective seals, damage or aging can nevertheless lead to leaks which, for example, can lead to the penetration of water or a mixture of fuel and oxygen-containing auxiliary substance entering the interior space surrounded by the protective housing. As a result, the fuel cells arranged therein may be exposed to influences which have an adverse effect on their durability as a result of corrosion, or alternatively an ignitable, explosive mixture of molecular hydrogen and molecular oxygen may form. Moreover, in the event of moisture collecting in the interior of the protective housing, the insulating action of insulating substances may be adversely affected or it is even possible that a short circuit may occur. To avoid these factors which have an adverse effect on the durability of the fuel cell arrangement, the atmosphere in the interior space of the protective vessel should be regularly exchanged and/or have the components which have an adverse effect on the durability of the fuel cell removed from it. To prevent the atmosphere from being released to the environment, the atmosphere is exchanged by recirculation in a recirculation circuit.

To reliably eliminate the components which have an adverse effect on the durability of the fuel cells from the atmosphere, a number of gas-purifying elements are advantageously connected into the recirculation circuit. In this context, it is possible in particular to provide filter elements which, in terms of their chemical reactivity, are specifically designed to remove components which have been found to be particularly disruptive from the gas stream which is guided in the recirculation circuit.

Water which is present in the atmosphere in the interior space of the protective housing could be regarded as being particularly problematical for this atmosphere. This is because this water could on the one hand lead to corrosion to the fuel cells themselves and to the feed systems which supply them, and could thereby increase possible leaks as fault sources. On the other hand, however, water which is present in the atmosphere of the interior space could also have effects on the conductivity of the atmosphere and thereby impair the reliability of the fuel cell arrangement with regard to insulation specifications which are to be observed. In a particularly advantageous configuration, the fuel cell arrangement is therefore designed for reliable removal of any water constituents from the gas stream which is guided in the recirculation circuit. For this purpose, a drying stage is expediently connected into the recirculation circuit.

For particularly simple operation, in a further advantageous configuration a water reservoir is connected to the drying stage. While the fuel cell arrangement is operating, water which has been extracted via the recirculation of the atmosphere in the recirculation circuit can be temporarily stored in this water reservoir, so that it can be disposed of just during maintenance work which is provided for in any case, for example after a predetermined maintenance interval has elapsed. The removal of water-containing constituents from the gas stream which is guided in the recirculation circuit can be carried out by means of binder, which is connected into the recirculation circuit in the manner of a filter, at a drying stage. Advantageously, however, the drying stage is designed as an element which can be actively manipulated while the fuel cell arrangement is operating and in which, depending on demand or depending on the current operating state of the fuel cell arrangement, modified drying of the gas stream which is guided in the recirculation circuit can be performed. For this, a condenser is advantageously provided as the drying stage.

For particularly simple manipulation while the fuel cell arrangement is operating, the action of the condenser can expediently be adjusted using electrical signals. For this purpose, the condenser can preferably be cooled by means of a number of Peltier elements.

A long-term, particularly high operational reliability for the fuel cell arrangement can be achieved if the formation of an ignitable mixture molecular hydrogen and molecular oxygen in the interior space of the protective housing is consistently suppressed. For this purpose, means for removing molecular hydrogen and/or molecular oxygen from the gas stream which is guided in the recirculation circuit are advantageously connected into the recirculation circuit. For this purpose, it is expediently possible to provide a number of reactors in which bonding of molecular hydrogen and/or of molecular oxygen takes place. The or each reactor which is intended to bond oxygen is in this case designed as what is known as a getter and comprises chemically active compounds, such as for example copper or zinc, which in the heated state preferentially react with molecular oxygen.

In an alternative advantageous configuration, controlled recombination of hydrogen with oxygen to form water is provided in order to avoid the formation of an ignitable mixture of molecular hydrogen and molecular oxygen in the interior space of the protective housing. For this purpose, a number of catalytic recombiners for reacting molecular oxygen with molecular hydrogen to form water is advantageously connected into the recirculation circuit. To reliably avoid the inherently undesirable loading of the atmosphere of the interior space of the protective housing with the water which is formed during this recombination, a drying stage, for example of the type described above, is advantageously connected downstream of the or each recombiner in the recirculation circuit.

In terms of the method for operating a fuel cell arrangement, the abovementioned object is achieved by gas which is located in the interior space of the protective housing being recirculated via the recirculation circuit and being dried and/or purified in the process.

The advantages which can be achieved by the invention consist in particular in the fact that reliable and long-term cleaning of the atmosphere which fills the interior space of the protective housing can be achieved by the recirculation in a closed recirculation circuit. In particular, the drying means in the recirculation circuit enable the water content of the atmosphere of the interior space to be kept at a relatively low level even in the event of minor leaks which may occur, for example where fuels or auxiliary substances are fed to the fuel cells, so that there is no great level of corrosion to the components arranged in the interior space of the protective housing. Furthermore, the formation of an explosive, ignitable mixture in the interior space of the protective vessel can be reliably avoided by means for removing molecular hydrogen and/or molecular oxygen from the gas stream which is guided in the recirculation circuit. The fuel cell arrangement which is designed in this manner therefore has a particularly long durability in combination with a high operational reliability.

An exemplary embodiment of the invention is explained in more detail with reference to a drawing, in which the FIGURE diagrammatically depicts a fuel cell arrangement.

The fuel cell arrangement 1 shown in the FIGURE comprises a large number of fuel cells which are connected up to form a diagrammatically depicted fuel cell block 2. Each fuel cell comprises both an anode and a cathode and a pair of electrodes, it being possible for a fuel which includes hydrogen to be fed to the anode and an auxiliary substance which includes oxygen to be fed to the cathode, via a system of feed lines which is not illustrated in more detail. Anode and cathode of each fuel cell are in this case electrically separated from one another by means of an electrolyte layer which, although it separates the fuel and auxiliary substance from one another in a gas-tight manner, does allow ion exchange between the fuel and the oxygen.

As a result of this ion exchange, an electrode voltage which amounts to between 0.6 and 1.0 V is established at the corresponding fuel cell. To generate a design voltage which is predetermined as a function of the intended use, the fuel cells in the fuel cell block 2 are electrically connected in series, in such a manner that the sum of their electrode voltages reaches or exceeds the output voltage required.

To protect against mechanical damage and also against environmental influences, such as spray water and dirt, the fuel cell block 2 is surrounded by a protective housing 4. The protective housing 4 has an interior space 6 which it surrounds and in which the fuel cell block 2 is arranged. The protective housing 4 surrounds, in a substantially gas-tight and water-tight manner, the interior space 6 and therefore also the fuel cell block 2 arranged therein, the feed lines 7 or inflow lines which are required in order to supply the fuel cells of the fuel cell block 2 with fuel and auxiliary substance, as well as electrical connection lines for removing the electricity which is generated in the fuel cell block 2 and for supplying control signals, being guided through the outer walls of the protective housing 4.

The fuel cell arrangement 1 is designed for a particularly long durability in combination with a high operational reliability. For this purpose, it is provided for the gas atmosphere which fills the interior space 6 to be kept relatively dry and free of components which attack the fuel cell block 2 arranged in the interior space 6.

It is true that on the one hand environmental atmosphere can enter the interior space 6 as a result of the abovementioned supply and connection lines being led through the outer walls of the protective housing 4, on account of leaks which may occur at these locations. On the other hand, there is also a possibility of leaks when supplying the fuel cells of the fuel cell block 2 themselves, in which case, by way of example, water and/or fuel and/or auxiliary substance may enter the interior space 6. In this case, in particular after a relatively long maintenance-free operating period, a certain water content may accumulate in the atmosphere of the interior space 6, and this could expose the internal fittings in the interior space 6 and in particular the components of the fuel cell block 2 to increased levels of corrosion, thereby reducing their durability. Moreover, on account of a rising water content in the atmosphere of the interior space 6, the required insulation resistance may flop or the insulating actions of insulating materials may deteriorate, and consequently short circuits may also occur as a result of liquid water condensing out. As an alternative or in addition, in the event of a leak of fuel and auxiliary substance into the interior space 6, an ignitable of mixture of molecular hydrogen and molecular oxygen could form in the interior space 6.

In order to safely and reliably avoid these disadvantageous effects on the durability and/or the operational reliability of the fuel cell arrangement 1, the interior space 6 which is surrounded by the protective housing 4 is gas-connected into a closed recirculation circuit 8. To form the recirculation circuit 8, an outflow line 10, which on the outlet side opens out into a recirculation pump 12, is connected to the interior space 6. On the outlet side or delivery side, the recirculation pump 12 is connected to an inflow line 14, in which a number of gas-purifying elements are connected. On the outlet side, the inflow line 14 opens out into the interior space 6 of the protective housing 4, so that a closed recirculation circuit 8 is formed.

As a first gas-purification element, a catalytic recombiner 16 is connected into the inflow line 14 and therefore into the recirculation circuit 8. The catalytic recombiner 16 comprises a catalytic element 20, which is arranged in a housing 18 and over which a gas stream G flowing through the catalytic recombiner 16 can be guided. In the exemplary embodiment, the catalytic element 20 has a catalytically active surface layer which comprises platinum as the catalytic substance. The catalytically active element 20 is therefore designed in such a manner that in the event that the gas stream fed to it comprises molecular hydrogen and molecular oxygen, it reacts them to form water in the manner of a recombination. Therefore, the catalytically active element 20 ensures that any molecular hydrogen and molecular oxygen which may be present in the gas stream G can be reliably removed, so that the formation of an ignitable, explosive mixture is reliably avoided. To improve the reaction rate in the catalytic recombination, it is also possible for the catalytically active element 20 to be designed such that it can be externally heated.

A drying stage is connected into the inflow line 14, downstream of the catalytic recombiner 16, as seen in the direction of flow of the gas stream G which is guided in the recirculation circuit 8. The drying stage is designed to separate or remove water from the gas stream G. The drying stage provided could be a vessel in which suitable chemical agents for bonding the water contained in the gas stream G are held. However, in the exemplary embodiment shown in the FIGURE, the drying stage provided is a condenser 22. The condenser 22, in the manner of a dew-point cooler, effects condensation of the water content out of the gas stream G guided in the recirculation circuit 8 by heat exchange therewith. The efficiency of the condensation can be adjusted by varying the cooling capacity of the condenser 22, so that the hydrogen separation in the condenser 22 provided as the drying stage can be matched to the current operating situation.

After cooling and condensation in the condenser 22, the remaining gas stream G can be reheated by lost heat.

A water reservoir 24, in which water which has been separated out of the gas stream G can be collected over a prolonged period, is connected to the condenser 22 which is provided as a drying stage. The water can then be removed from the water reservoir 24 during maintenance of the fuel cell arrangement 1 which is carried out on a regular basis. Therefore, there is no need for the water which has been separated out of the gas stream G to be continuously discharged; this allows particularly resource-friendly operation of the fuel cell arrangement 1 between the maintenance intervals which are in any case provided.

The condenser 22 may be coolable by means of cooling air or by means of a number of Peltier elements arranged in its interior space. In the exemplary embodiment, however, the condenser 22 can be cooled by means of cooling water which is guided in a number of cooling coils 26 arranged in the interior space of the condenser 22. The cooling capacity of these cooling coils can be adjusted in a particularly simple way by means of the cooling flow in the connection lines 29, 30.

In terms of its cooling capacity and its other operating parameters, the condenser 22 is dimensioned in such a manner that there is sufficient capacity for reliable removal of water which has entered the interior space 6 as a result of leaks from the fuel cell block 2 or its inflow lines and water which has formed as a result of catalytic recombination in the recombiner 16.

As a further gas-purifying element, a fine filter 28 is connected into the inflow line 14, downstream of the condenser 22, as seen in the direction of flow of the gas stream G which is guided in the recirculation circuit 8.

By way of example, dust particles or residual impurities can be removed from the gas stream G in the fine filter 28.

When the fuel cell arrangement 1 is operating, the gas atmosphere located in the interior space 6 surrounded by the protective housing 4 is continuously recirculated in the recirculation circuit 8. For this purpose, the gas stream G is removed from the interior space 6 and is passed, by means of the recirculation pump 12, via the components which are provided as gas-purifying elements, namely catalytic reactor 16, condenser 22 and fine filter 28, before being fed back into the interior space 6 via the inflow line 14. This allows long-term recirculation of the atmosphere of the interior space 6. In the process, undesirable impurities and constituents which have a particularly adverse effect on the durability and operational reliability of the fuel cell arrangement 1, such as in particular water and molecular hydrogen from the gas stream G and therefore from the atmosphere, are removed from the interior space 6. Therefore, even after a prolonged operating time, there is no possibility of an increase in the levels of the abovementioned substances, which could in turn lead to corrosion or to the ability of individual components arranged in the interior space 6 being impaired.

1. A fuel cell arrangement (1), having a number of fuel cells arranged in a protective housing (4), in which arrangement the interior space (6) surrounded by the protective housing (4) is gas-connected into a closed recirculation circuit (8).

2. The fuel cell arrangement (1) as claimed in claim 1, which has a number of gas-purifying elements connected into its recirculation circuit (8).

3. The fuel cell arrangement (1) as claimed in claim 1 or 2, which has a drying stage connected into its recirculation circuit (8).

4. The fuel cell arrangement (1) as claimed in claim 3, which has a water reservoir (24) connected to its drying stage.

5. The fuel cell arrangement (1) as claimed in claim 3 or 4, in which a condenser (22) is provided as the drying stage.

6. The fuel cell arrangement (1) as claimed in claim 5, in which the condenser (22) can be cooled by a number of cooling coils (26).

7. The fuel cell arrangement (1) as claimed in one of claims 1 to 6, which have a number of reactors for bonding molecular hydrogen and/or molecular oxygen connected into its recirculation circuit (8).

8. The fuel cell arrangement (1) as claimed in one of claims 1 to 7, which has a number of catalytic recombiners (16) for reacting molecular oxygen with molecular hydrogen to form water connected into its recirculation circuit (8).

9. The fuel cell arrangement (1) as claimed in claim 8, in which a drying stage is connected downstream of the or each catalytic recombiner (16) in the recirculation circuit (8).

10. A method for operating the fuel cell arrangement (1) as claimed in one of claims 1 to 9, in which gas which is located in the interior space (6) in the protective housing (4) is recirculated via the recirculation circuit (8) and is dried and/or purified in the process.
